(19) United States
(12) Patent Application Publication
(10) Pub. No.: US 2014/0379222 A1
(43) Pub. Date: Dec. 25, 2014

(54) METHOD AND DEVICE FOR ANALYZING A COLLISION OF A VEHICLE

(71) Applicant: ROBERT BOSCH GMBH, Stuttgart (DE)

(72) Inventors: Stephan Rittler, Urbach (DE); Olaf Koerner, Hamburg (DE); Alexander Brandt, Kanagawa (JP)

(21) Appl. No.: 14/356,299

(22) PCT Filed: Oct. 31, 2012
(86) PCT No.: PCT/EP2012/071541

§ 371 Date: May 5, 2014

(30) Foreign Application Priority Data
Nov. 7, 2011 (DE) 10 2011 085 843.1

(51) Int. Cl. B60R 21/0132

(52) U.S. Cl. CPC B60R 21/0132
USPC 701/45

(57) ABSTRACT

A method for analyzing a collision of a vehicle includes a step of determining a collision area on the vehicle, based on a rotational value which represents a rotation or a rotational state about a vertical axis of the vehicle.

### BACKGROUND OF THE INVENTION

1. Field of the Invention

The present invention relates to a method for analyzing a collision of a vehicle, a corresponding device, and a corresponding computer program product.

2. Description of the Related Art

During a collision of a vehicle, an occupant of the vehicle may be injured by an impact with lateral structures of the vehicle. A side airbag, for example, may be used to prevent this.

Published German patent application document DE 10 2009 002 922 A1 relates to a side airbag for a vehicle.

### BRIEF SUMMARY OF THE INVENTION

During a vehicle collision, in principle the activation of restraint means is determined by the type and the severity of the collision. The type as well as the severity of the collision to be expected may be assessed by the combined signal evaluation of acceleration sensors, roll rate sensors, and pressure sensors integrated into the vehicle, as well as anticipatory sensors such as radar.

The signal patterns and changes in speed in the longitudinal and lateral directions may be evaluated via the acceleration sensors. The progress of a vehicle rollover motion about the longitudinal axis may be assessed via the roll rate. Flat collision contacts may be quickly recognized via pressure sensors, and essentially the collision speed and collision overlap may be detected via anticipatory sensors. Evaluation algorithms for evaluating sensor signals, as well as the sensor configuration, may be designed and applied based on standardized crash tests.

The combined consideration of linear and gyratory changes in motion have thus far played a subordinate role in the collision classification of standardized crash tests, while in the field the combination of linear and gyratory changes in motion during the collision may frequently be observed. In the case of combined linear and rotational accelerations, the transmission of force into the vehicle during the collision may have a significant influence on the movement of the occupants, and thus on the optimal activation of various restraint means. Therefore, a collision type classification should not only be set up based on linear changes in motion, but should also take into account the transmission of force in relation of a collision-induced yaw, roll, and rollover movement.

The location on the vehicle of the point of contact which triggers the collision may be determined by considering, for example, a yaw rate of the vehicle during a collision of the vehicle. Occupant protection means of the vehicle, for example, may be activated in a targeted manner with knowledge of the point of contact.

A distance of the transmission of force which triggers the collision from the center of mass of the affected vehicle may be determined from the point of contact, or vice versa. This allows classification of a collision situation, taking rotational and linear changes in motion during the collision into account, by recognizing the distance of the transmission of force from the center of mass of the affected vehicle. A head-on “low overlap” collision, i.e., a collision in which the frontal point of collision is greatly different from the center of the vehicle, may be recognized in this way.

A method for analyzing a collision of a vehicle includes the following step:

Determining a collision area on the vehicle regarding the collision, based on a rotational value which represents a rotation or a rotational state about a vertical axis of the vehicle.

The vehicle may be a motor vehicle such as a passenger vehicle or a truck. The collision or crash may be caused by an impact of the vehicle with another vehicle or with an object in general. Accelerations or deformations of the vehicle which are hazardous for an occupant may occur due to the collision. Injury of the occupant may be reduced by appropriate occupant protection means such as an airbag. A classification of the collision may be made with the aid of the method. Based on a result of the classification, one or multiple appropriate occupant protection means may be selected and triggered to mitigate the effects of the collision. The classification of the collision may be made based on the collision area. The collision area may be the area of the vehicle that is directly affected by the collision. This may be an area in the periphery of the vehicle or an area of an exterior surface of the vehicle. The collision area may include an impact surface which is acted on by a transmission of force caused by the collision. In addition, the collision area may represent a point of contact. The point of contact may be a midpoint or center of gravity of the impact surface, for example. The point of contact may represent a point at which a transmission of force into the vehicle occurs which represents the collision. Via the collision area, a definition may be made as to whether the collision is caused by an impact acting centrally on the vehicle or by an impact which is offset laterally with respect to a center of the vehicle. The rotational value may represent a value which is provided by a sensor of the vehicle or which is determined from one or successive values of this type. Thus, the collision area may also be determined based on a rate of change of the rotational value over time. The rotational value may be provided during the collision, and may thus be determined or influenced by the collision. A vertical axis may represent a vertically extending axis. A vertical axis may extend through a center of gravity of the vehicle. The rotational value may represent a value or a signal that is provided by a sensor, for example a yaw rate sensor, or a sensor evaluation circuit.

The rotation may represent a rotational acceleration or a rotational speed. The rotation may thus be a yaw rate or yaw acceleration of the vehicle. The rotational state may represent a rotational angle, and may thus be a yaw angle. Such values are already being commonly detected in vehicles, so that the method may be applied to sensor signals that are already present.

The method may include a step of comparing a longitudinal acceleration in a longitudinal direction of the vehicle to a threshold value. The collision may be recognized via the comparison. The longitudinal acceleration may represent a value or a signal that is provided by an acceleration sensor of the vehicle. The threshold value may include a value for a reference acceleration. If an instantaneous longitudinal acceleration of the vehicle is greater than the threshold value, this may be an indication of the collision. The collision may have occurred in particular due to a head-on or rear end collision. If the collision is recognized by evaluating the longitudinal acceleration, the collision area may be subsequently determined based on an evaluation of the rotational value.

The method may include a step of comparing a transverse acceleration in a transverse direction of the vehicle to a further threshold value. The plausibility of a recognition of the collision based on the longitudinal acceleration may be checked via the further comparison. The transverse acceleration may represent a value or a signal that is provided by a further acceleration sensor of the vehicle. The further threshold value may include a value for a further reference acceleration. If an instantaneous transverse acceleration of the vehicle is greater than the further threshold value, this may be an indication of a collision that is caused by a side impact. If the instantaneous transverse acceleration of the vehicle is less than the further threshold value, this may be an indication of a collision that is triggered by a head-on or rear end impact. By evaluating the longitudinal acceleration as well as the transverse acceleration, on the one hand the collision may be reliably recognized, and on the other hand the type of collision, i.e., either a side collision or a head-on or rear end collision, may be determined. The collision area may thus be determined based on the rotational value, using the knowledge concerning the collision and the type of collision. This allows a very accurate determination of the collision area.

The method may include a step of comparing the rotational value to at least one classification value. A classified rotational value may be obtained via the comparison. The collision area may be determined in the determination step, based on the classified rotational value. For example, a magnitude of the rotational value may be classified using the at least one classification value. The at least one classification value may be predefined. In this way, the rotational value may be associated with one of at least two predefined possible classified rotational values via the comparison. Likewise, an association between the at least two predefined possible classified rotational values and possible collision areas may be predefined. In this way, the collision area may be determined, independently of a comparison result, from the comparison of the rotational value to the at least one classification value. Depending on whether the rotational value is greater or smaller than a classification value, the rotational value may be associated with a first class or a second class. The classification value may thus represent a division between two adjoining classes.

The method may include a step of associating the rotational value with one of at least two classes. An area of the vehicle may be assigned to each of the at least two classes. In the determination step, the collision area may be determined as that area of the vehicle which is assigned to the class that is associated with the rotational value in the association step. The number of collision areas that are provided may be established via the classes. In addition, the classes allow a simple and rapid association between the rotational value and the collision area.

In the determination step, the collision area may also be determined based on an algebraic sign of the rotational value, and additionally or alternatively, an algebraic sign of a transverse acceleration of the vehicle. Which side of the vehicle the collision area is situated on may be determined by using the algebraic sign.

The method may include a step of selecting at least one occupant protection means associated with the collision area as the occupant protection means to be activated due to the collision. The vehicle may include a plurality of activatable occupant protection means. If a collision and subsequently a collision area are determined, it is possible to activate only those occupant protection means of the plurality of activatable occupant protection means which are associated with the collision area that is determined for the collision. The determined collision area may be one collision area from a plurality of possible collision areas. An independent group of occupant protection means may be associated with each of the possible collision areas. The groups may differ with respect to the type and number of occupant protection means. A group of occupant protection means may include none, one, two, three, or more occupant protection means. One occupant protection means from the plurality of activatable occupant protection means may be associated with one or multiple possible collision areas. The association between the occupant protection means and the collision areas may be predefined. Depending on the collision area, the appropriate occupant protection means may be activated very quickly in this way. Likewise, unnecessary activation of individual occupant protection means may be avoided.

The present invention also provides a device which is designed to carry out or implement the steps of the method according to the present invention in appropriate units. The object of the present invention may also be achieved quickly and efficiently by this embodiment variant of the present invention in the form of a device.

In the present context, a device may be understood to mean an electrical device, a control unit, for example, which processes sensor signals and outputs control and/or data signals as a function thereof. The device may have an interface which may have a hardware and/or software design. In a hardware design, the interfaces may be part of a so-called system ASIC, for example, which contains various functions of the device. However, it is also possible for the interfaces to be dedicated, integrated circuits, or to be at least partially composed of discrete components. In a software design, the interfaces may be software modules which are present on a microcontroller, for example, in addition to other software modules.

Also advantageous is a computer program product having program code which may be stored on a machine-readable medium such as a semiconductor memory, a hard drive, or an optical memory, and used for carrying out the method according to one of the above-described specific embodiments when the program is executed on a computer or a device.

The present invention is explained in greater detail below as an example, with reference to the appended drawings.

### BRIEF DESCRIPTION OF THE DRAWINGS

FIG. 1 shows a schematic illustration of a vehicle according to one exemplary embodiment of the present invention.

FIG. 2 shows a flow chart of one exemplary embodiment of the present invention.

FIG. 3 shows a schematic illustration of a vehicle according to one exemplary embodiment of the present invention.

FIG. 4 shows a graphic illustration of a collision pattern.

### DETAILED DESCRIPTION OF THE INVENTION

In the following description of preferred exemplary embodiments of the present invention, identical or similar reference numerals are used for the elements having a similar action which are illustrated in the various figures, and a repeated description of these elements is dispensed with.

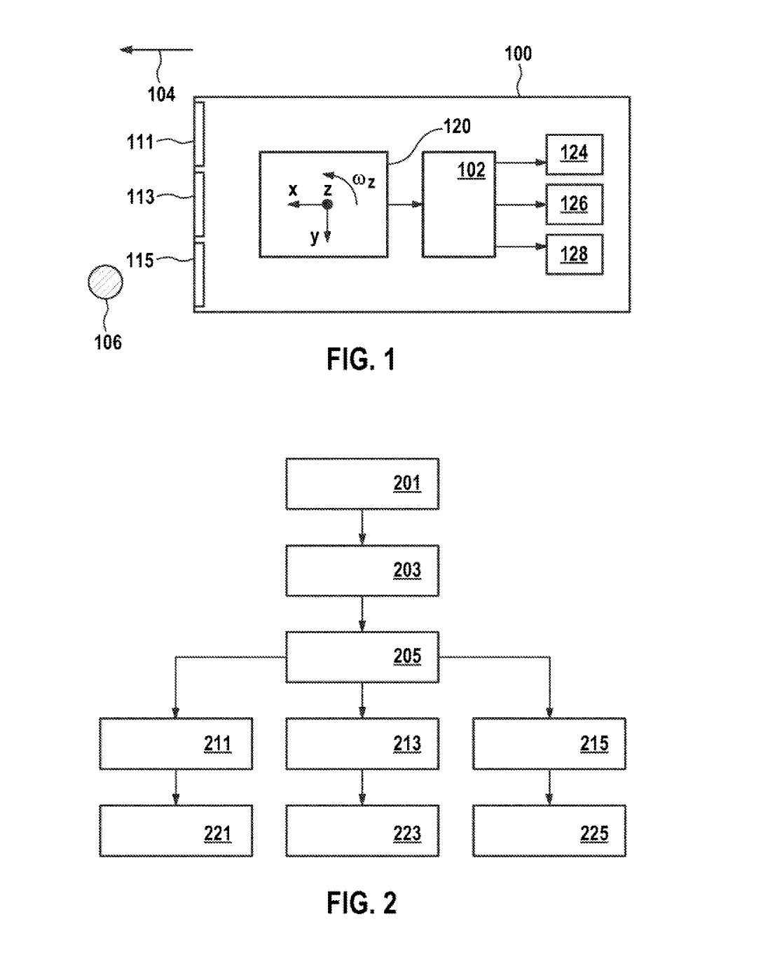

FIG. 1 shows an illustration of a vehicle 100 having a device 102 for analyzing a collision of vehicle 100. Vehicle 100 is moving forward in a direction of travel 104. Vehicle 100 is moving toward an obstruction 106. In the situation shown in FIG. 1, obstruction 106 is situated ahead of vehicle 100 in direction of travel 104. If vehicle 100 continues to move in direction of travel 104, a collision between vehicle 100 and obstruction 106 will occur.

A vehicle front end of vehicle 100, for example a front bumper, is subdivided into multiple areas 111, 113, 115. The vehicle front end is subdivided into multiple areas 111, 113, 115 in the horizontal direction. Areas 111, 113, 115 are situated next to one another. According to this exemplary embodiment, areas 111, 113, 115 do not overlap. Area 113 is situated in the center of the vehicle front end. Area 111 is situated to the right of area 113, viewed in direction of travel 104. Area 115 is situated to the left of area 113, viewed in direction of travel 104.

According to this exemplary embodiment, three areas 111, 113, 115 are provided. A greater or smaller number of areas may also be provided. Similarly, the vehicle rear end may be subdivided into areas, so that the approach described below may also be implemented for a collision occurring at the vehicle rear end.

If vehicle 100 continues to move in direction of travel 104, vehicle 100 will hit obstruction 106 with area 115. Area 115 thus represents the collision area for the collision of vehicle 100 with obstruction 106. Thus, a point of contact between vehicle 100 and obstruction 106 is present within collision area 115.

Collision area 115 may be determined with the aid of device 102 for analyzing a collision of vehicle 100.

According to this exemplary embodiment, vehicle 100 has a sensor 120 and multiple occupant protection means 124, 126, 128. Device 102 is designed to receive at least one rotational value from sensor 120, and to determine collision area 115 based on at least one rotational value received after the start of the collision with obstruction 106.

One or multiple occupant protection means 124, 126, 128 may be associated with each of areas 111, 113, 115. For example, occupant protection means 124, 126 may be associated with area 115, occupant protection means 126 may be associated with area 113, and occupant protection means 126, 128 may be associated with area 111. For example, occupant protection means 124 may be a right side airbag, viewed in direction of travel 104, occupant protection means 126 may be a front airbag, and occupant protection means 128 may be a left side airbag, viewed in direction of travel 104.

According to this exemplary embodiment, sensor 120 is designed to detect a rotational speed or rotational rate ω_{z} of vehicle 100 about a vertical axis z of vehicle 100, and to output same as a rotational value to device 102. Vertical axis z may extend through the center of gravity of vehicle 100. Thus, rotational rate ω_{z} may be a yaw rate. As an alternative or in addition to rotational rate ω_{z}, a rotational acceleration about vertical axis z or a rotational angle about vertical axis z may be used by device 102 as the rotational value.

According to this exemplary embodiment, sensor 120 is designed to detect a longitudinal acceleration of vehicle 100 along a longitudinal axis x of vehicle 100. In addition, sensor 120 is designed to detect a transverse acceleration of vehicle 100 along a transverse axis y of vehicle 100. Sensor 120 is designed to output signals, which include values of the longitudinal acceleration and the transverse acceleration, to device 102. Device 120 is designed to recognize a collision based on the longitudinal acceleration and the transverse acceleration, and to classify same as a collision from the front, a collision from the rear, or a collision from the side.

Sensor 120 may include one sensor unit or multiple sensor units, which may also be situated at different positions in vehicle 100.

If vehicle 100 collides with obstruction 106, sensor 120 initially detects a longitudinal acceleration, and subsequently detects a transverse acceleration which is less than the longitudinal acceleration, as well as a rotational rate ω_{z}. Device 102 is designed to recognize, based on the longitudinal acceleration and optionally also based on the transverse acceleration, that the collision with obstruction 106 is a frontal impact. By evaluating rotational rate ω_{z}, device 102 is also designed to establish collision area 115 as the point of contact between vehicle 100 and obstruction 106. For determining the type of collision and/or the collision area, device 102 may be designed to evaluate absolute values of the accelerations and of rotational rate ω_{z}, and additionally or alternatively to evaluate a variation over time of a change in values of the accelerations and rotational rate ω_{z}. In addition, for determining the type of collision and/or the collision area, device 102 may be designed to evaluate a temporal relationship between changes in the values of the accelerations and rotational rate ω_{z}. Furthermore, for determining the type of collision and/or the collision area, device 102 may be designed to evaluate a ratio of the longitudinal acceleration to the transverse acceleration, and/or a ratio of one of the accelerations to rotational rate ω_{z}.

According to one exemplary embodiment, a head-on collision or a frontal impact is recognized via a strong signal in the x direction, i.e., the longitudinal direction of the vehicle. This may involve an acceleration in the longitudinal direction. For example, the head-on collision may be recognized as such when the acceleration in the longitudinal direction (Acc_X) is greater than a threshold. After a brief delay, in the present case approximately 5 ms after the collision of vehicle 100 with obstruction 106, yaw rate signal ω_{z} shows a strong signal, for example in the form of a deflection which exceeds a predefined threshold.

In addition, it has been shown that the acceleration in the y direction, i.e., in the transverse direction of the vehicle, is much less in comparison to a side collision, regardless of the point of impact. However, a y acceleration, i.e., a transverse acceleration, may still be recognized. The transverse acceleration may be used as a plausibility check.

The estimation of the point of contact is now based on the evaluation of the yaw acceleration. If a strong yaw acceleration is to be identified, it may be inferred that the point of impact moves from the center of the vehicle front end toward the side, in the direction of a headlight or turn signal, for example. The yaw acceleration may now be subdivided into classes which in turn are associated with front end areas. The yaw acceleration may be determined from yaw rate ω_{z}, or vice versa.

The rotational direction, i.e., whether the point of contact is situated to the left or to the right of the center of the vehicle, may be ascertained via the algebraic sign of yaw rate ω_{z} and/or the y acceleration.

FIG. 2 shows a flow chart of a method for analyzing a collision of a vehicle according to one exemplary embodiment of the present invention. The vehicle may be, for example, vehicle 100 shown in FIG. 1. The method may be implemented, for example, by device 102 shown in FIG. 1.

A longitudinal acceleration of the vehicle is compared to a threshold value in a step 201. A start of the collision may be recognized based on a comparison result obtained from the comparison. For example, a collision may be assumed when a value of the longitudinal acceleration is greater than the threshold value for the first time or over a predefined period of time.

A transverse acceleration of the vehicle is compared to a further threshold value in a step 203. Based on a further comparison result obtained from the comparison, a plausibility check may be made of the recognition of the collision based on the longitudinal acceleration. For example, the comparison of the transverse acceleration to the further threshold value may be made after the start of the collision has been recognized based on the longitudinal acceleration. If the transverse acceleration at a point in time after the start of the collision is less than the longitudinal acceleration at that point in time, it may be assumed that a head-on collision or a rear end collision, and not a side collision, is involved. The further threshold value may be predefined, or may be set as a function of a value of the longitudinal acceleration.

A rotational value which represents a rotation or a rotational state about a vertical axis of the vehicle may be compared to at least one classification value in a step 205 in order to obtain a classified rotational value. The rotational value may be classified, i.e., associated with a plurality of classes, via the comparison. According to this exemplary embodiment, three classes 211, 213, 215 are shown. A possible collision area of the vehicle may be associated with each of classes 211, 213, 215. For example, as shown in FIG. 1, area 111 may be associated with class 211, area 113 may be associated with class 213, and area 115 may be associated with class 215.

A group 221, 223, 225 of occupant protection means is associated with each of classes 211, 213, 215 or with each collision area that is defined by a class. For example, as shown in FIG. 1, occupant protection means 124, 126 may be associated with group 225, occupant protection means 126 may be associated with group 223, and occupant protection means 126, 128 may be associated with group 221. Thus, by associating the rotational value with one of classes 211, 213, 215 in step 205, a group 221, 223, 225 of occupant protection means is selected which may be subsequently activated.

Step 205 may be carried out in response to a recognition of a collision via steps 201, 203. Step 203 for plausibility checking of the collision is optional. Steps 201, 203 may both be optionally carried out. For example, steps 201, 203 may be skipped if information about the collision is ascertained in some other way or is already available.

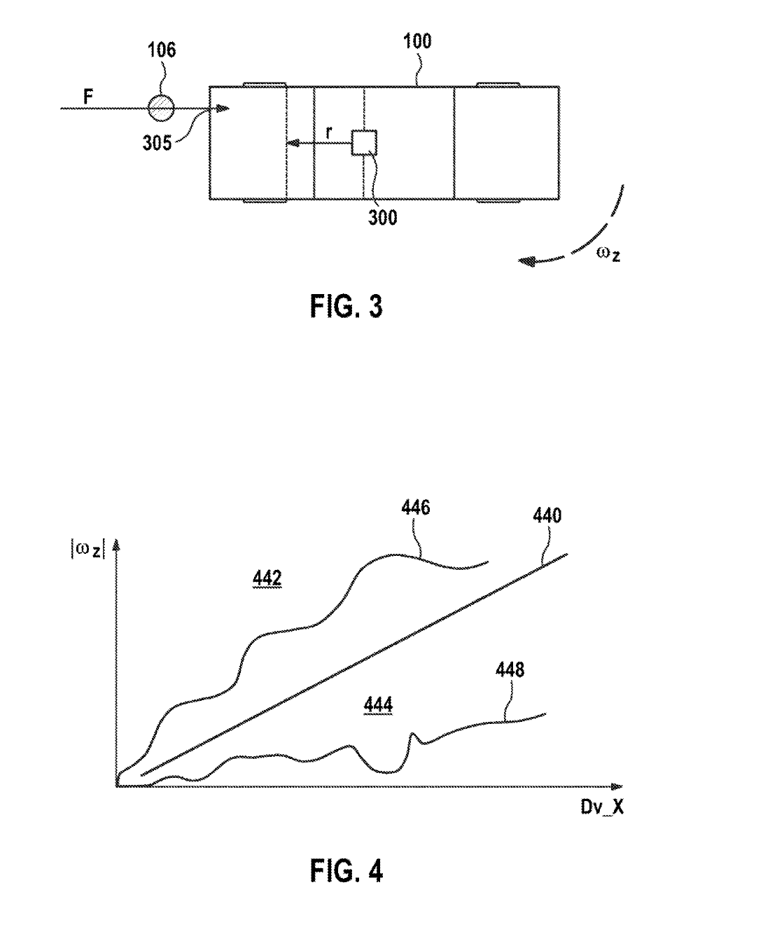

FIG. 3 shows a schematic illustration of a vehicle 100 according to one exemplary embodiment of the present invention. This may be vehicle 100 shown in FIG. 1. Vehicle 100 has a center of mass 300. An effect of a force F due to a collision of vehicle 100 with an obstruction 106 is shown.

According to this exemplary embodiment, at the start of the collision a point of contact 305 is situated between obstruction 106 and vehicle 100 in a collision area at the front side of vehicle 100, specifically, on the right half of the front side. Force F therefore acts with a lateral offset with respect to center of gravity 300 of vehicle 100. Thus, there is a lateral offset between center of gravity 300 and a point of contact 305 between the obstruction and vehicle 100.

An inertial force r of vehicle 100 initially counteracts force F. Inertial force r acts in the direction of travel of vehicle 100. Vehicle 100 is set in rotation by the action of force F, offset with respect to center of gravity 300. A direction of a resulting yaw rate ω_{z} is indicated by an arrow.

According to the described exemplary embodiments, a joint assessment of rotational and linear acceleration information takes place which is used for recognizing discrete collision scenarios. A determination is made of a universal feature of complex collision patterns which include linear as well as gyratory changes in motion.

Point of contact 305 or the collision area is ascertained, which allows conclusions to be drawn about the subsequent gyratory characteristic, for example yaw rate ω_{z}, in the collision pattern. If a large gyratory characteristic is to be expected, in addition to the customary front restraint means such as airbags and seat belt tensioners, laterally acting occupant protection means such as window airbags and, if present, restraint means integrated into the seat, for example a collision-active seat having a side support function or an active seat adjustment, should be activated, since it is to be expected here that the heads of the occupants describe a curved path which ends in the immediate vicinity of the B-pillar.

Instead of yaw rate ω_{z}, a derivative of yaw rate ω_{z}, such as the yaw angle or the yaw acceleration may be used.

The scenario shown in FIG. 3 may be a “low overlap”-like application of force.

FIG. 4 shows a graphic illustration in which yaw rate ω_{z}, is shown in relation to longitudinal acceleration DV_X. A diagram is shown in which longitudinal acceleration DV_X is plotted on the abscissa and the absolute value of yaw rate ω_{z} is plotted on the ordinate. A threshold 440 subdivides the space spanned by the abscissa and the ordinate into two subspaces 442, 444. Threshold 440 is formed by a line through the origin. Subspace 442 represents an area which is associated with collisions of the “low overlap crash” type. Subspace 444 represents an area with which all other types of collisions are associated, for example offset deformable barrier (ODB) collisions, angled collisions, flat frontal (FF) collisions, or no-fire collisions in which no occupant protection means are activated.

Two characteristic curves 446, 448 are plotted. Characteristic curve 446 shows an example of a pattern of a relationship between the absolute value of yaw rate ω_{z} and longitudinal acceleration DV_X during a “low overlap” collision, as described with reference to FIGS. 1 and 3, for example. Characteristic curve 448 shows an example of a pattern of a relationship between the absolute value of yaw rate ω_{z}, and longitudinal acceleration DV_X during a collision which is not a “low overlap” collision.

The differentiation as to whether an impact has occurred at the rear end or the front end, i.e., whether the collision has occurred from the front or from the rear, may be made by a comparison of the algebraic signs of yaw rate ω_{z} and the y acceleration, i.e., the transverse acceleration.

The described exemplary embodiments allow recognition of a low overlap collision by evaluating yaw rate signal ω_{z}. The approach may be implemented, for example, in control unit designs in which yaw rate sensors as well as acceleration sensors are integrated into the corresponding plane of rotation. For the collision classification of gyratory collisions, a descriptive collision feature in the form of the collision area or the point of contact is established for the definition of an appropriate activation plan for restraint means in such complex collision situations.

The described approach is suitable for enabling paths for yaw rate-based algorithms for triggering occupant protection means.

The exemplary embodiments which are described and shown in the figures have been selected only as examples. Different exemplary embodiments may be combined with one another, either completely or with respect to individual features. In addition, one exemplary embodiment may be supplemented by features of another exemplary embodiment. Furthermore, method steps according to the present invention may be repeated, and carried out in a sequence different from that described. The method steps may be carried out with continuous repetition.

1-10. (canceled)

11. A method for analyzing a collision of a vehicle, comprising:
determining an area of the vehicle involved in the collision, based on one of (i) a rotational value which represents a rotation about a vertical axis of the vehicle or (ii) a rotational state about the vertical axis of the vehicle.

12. The method as recited in claim 11, wherein the rotation is one of a rotational acceleration or a rotational speed, and the rotational state represents a rotational angle.

13. The method as recited in claim 12, further comprising:
comparing a longitudinal acceleration in a longitudinal direction of the vehicle to a threshold value in order to recognize the collision.

14. The method as recited in claim 13, further comprising:
comparing a transverse acceleration in a transverse direction of the vehicle to a further threshold value in order to check the plausibility of a recognition of the collision based on the longitudinal acceleration.

15. The method as recited in claim 13, further comprising:
comparing the rotational value to at least one classification value in order to obtain a classified rotational value;
wherein the area of the vehicle involved in the collision is determined based on the classified rotational value.

16. The method as recited in claim 15, wherein the rotational value is associated with one of at least two classes, each one of the at least two classes having an assigned area of the vehicle, and wherein the area of the vehicle which is assigned to the class associated with the rotational value is determined as the area of the vehicle involved in the collision.

17. The method as recited in claim 16, wherein the area of the vehicle involved in the collision is determined further based on at least one of an algebraic sign of the rotational value and a transverse acceleration of the vehicle.

18. The method as recited in claim 16, further comprising:
selecting at least one occupant protection unit associated with the area of the vehicle involved in the collision as the occupant protection unit to be activated due to the collision.

19. A device for analyzing a collision of a vehicle, comprising:
means for determining an area of the vehicle involved in the collision, based on one of (i) a rotational value which represents a rotation about a vertical axis of the vehicle or (ii) a rotational state about the vertical axis of the vehicle, wherein the rotation is one of a rotational acceleration or a rotational speed, and the rotational state represents a rotational angle;
means for comparing a longitudinal acceleration in a longitudinal direction of the vehicle to a threshold value in order to recognize the collision; and
means for comparing the rotational value to at least one classification value in order to obtain a classified rotational value;
wherein the area of the vehicle involved in the collision is determined based on the classified rotational value.

20. A non-transitory computer-readable data storage medium storing a computer program having program codes which, when executed on a computer, performs a method for analyzing a collision of a vehicle, comprising:
determining an area of the vehicle involved in the collision, based on one of (i) a rotational value which represents a rotation about a vertical axis of the vehicle or (ii) a rotational state about the vertical axis of the vehicle, wherein the rotation is one of a rotational acceleration or a rotational speed, and the rotational state represents a rotational angle;
comparing a longitudinal acceleration in a longitudinal direction of the vehicle to a threshold value in order to recognize the collision; and
comparing the rotational value to at least one classification value in order to obtain a classified rotational value;
wherein the area of the vehicle involved in the collision is determined based on the classified rotational value.
